(19) United States
(12) Patent Application Publication
(10) Pub. No.: US 2023/0076691 A1
(43) Pub. Date: Mar. 9, 2023

(54) FOUNDATION FOR A WIND TURBINE

(71) Applicant: ANKER WERK I PORT MUKRAN GMBH, Sassnitz (DE)

(72) Inventors: Christoph SCHRIEFER, Redefin (DE); Gregor PRASS, Hamburg (DE)

(21) Appl. No.: 17/762,842

(22) PCT Filed: Oct. 2, 2020
(86) PCT No.: PCT/EP2020/077693

§ 371 Date: Nov. 10, 2022

(30) Foreign Application Priority Data
Oct. 2, 2019 (DE) 10 2019 126 558.4

(51) Int. Cl. E02D 27/42; F03D 13/20

(52) U.S. Cl. CPC E02D 27/425; F03D 13/22; E02D 2250/0023; E02D 2300/002

(57) ABSTRACT

The invention relates to a foundation (10) for a wind turbine substantially consisting of a concrete-cast plinth-like portion (11) having at least one cast-in-situ tower fastening element (60) located therein on which a tower of the wind turbine can be arranged and to which the tower of the wind turbine can be connected, and of a second, substantially horizontally extending portion (12) as planar foundation body, wherein the second portion (12) is arranged connected to the first portion (11), and wherein the second portion (12) of the foundation (10) substantially consists of at least three prefabricated horizontal elements (22), preferably made of reinforced concrete. There is provision here that the at least three horizontal elements (22) each have at least one base portion (23) with a stiffening element (26) extending substantially vertically thereon, that the horizontal elements (22) can be arranged in dependence on the parameters of the tower to be erected, in particular the tower radius, and that there is in each case a distance (B) between the horizontal elements (22).

The invention relates to a foundation for a wind power plant with a first pedestal-like section, cast substantially from concrete at the erection site having at least one tower fastening element located therein, and cast into on site, on which a tower of the wind power plant is arrangeable, and to which the tower of the wind power plant is can be connectable, and with a second substantially horizontally extending section as a flat foundation body, the second section being arranged in connection with the first section, and the second section of the foundation consisting substantially at least of three prefabricated horizontal elements, preferably made from reinforced concrete.

Furthermore, the invention relates to a method for erecting a foundation for a wind power plant.

Foundations for wind power plants are configured substantially as cast-in-place concrete foundations. For this purpose, a pit is excavated at the erection location, and is provided with a granular subbase. Subsequently, the formwork and the reinforcement are erected, and it is filled completely with concrete on site. Here, a flat body is possibly erected with a pedestal; see, for example, US 20160369520 A1. In addition to the expenditure on transport as a result of the delivery of the concrete, the formwork and the reinforcement, this is highly intensive in terms of work and time on site. Quality control is also complicated and/or also associated with problems depending on weather conditions. Furthermore, the dismantling after the end of the service life of the wind power plant is expensive and highly complicated.

Furthermore, there is in principle demand for foundations of wind power plants to be erected from prefabricated elements, whereby the abovementioned problems might be reduced or eliminated. It is in principle advantageous that, in the case of prefabrication, the components can be produced in a standardized manner under defined conditions. The outlay on work on site is also reduced. For this purpose, various approaches have been described in the prior art.

For example, WO 2008/036934 A2 discloses a combination of prefabricated elements and classic formwork/reinforcement construction. EP 22563387 A1 discloses a foundation for a wind power plant. A foundation is erected from prefabricated concrete parts on site after a corresponding delivery. It comprises a flat section and a pedestal-like section. The ribs have horizontally projecting anchor elements which, in the assembled state, extend radially into the center of the foundation. Slabs are provided below and above the anchors. The cast-in-place concrete is introduced into the cavity which is formed in this way, in order to connect the anchors to one another and to form a central body. As a result, the abovementioned disadvantages are reduced only insignificantly.

It is therefore an object of the invention to overcome the abovementioned disadvantages and to make it possible for foundations for wind power plants, in particular for wind power plants with concrete towers, to be erected economically from prefabricated elements.

With regard to the foundation, the object according to the invention is achieved by virtue of the fact that the at least three horizontal elements each have at least one base section with a reinforcing element extending substantially vertically thereon, in that the horizontal elements are arrangeable in a manner which is dependent on the parameters of the tower to be erected, in particular the tower radius, and in that there is in each case a spacing between the horizontal elements.

With regard to the method, the object according to the invention is achieved by way of the steps:

arranging of at least one tower fastening element in a pedestal section of the foundation, arranging of at least three horizontal elements, prefabricated substantially from concrete, radially around the tower fastening element, with the result that in each case at least one connecting element which exits from the horizontal element protrudes into the pedestal section, the horizontal elements being arranged in such a way that there is in each case a spacing between horizontal elements,

introducing of reinforcements into the pedestal section,

erecting of formwork for spatially delimiting the pedestal section, and introducing of cast-in-place concrete into the formwork.

As a result, the abovementioned foundations can be simplified considerably with regard to assembly and material complexity. In particular, it is possible to erect foundations for different tower radii by way of one horizontal element type, by the horizontal elements being correspondingly displaced in parallel, the horizontal elements remaining identical in construction.

A further teaching of the invention provides that the spacing is covered with at least one covering element. It has been shown that, as a result, an increase in the load can be achieved in a simple way by way of introducing of soil onto the upper side of the foundation.

A further teaching of the invention provides that the first section has reinforcements which are cast on site. They are preferably at least partially prefabricated. As a result, a pedestal which satisfies the necessary static requirements can be produced in a simple way.

A further teaching of the invention provides that the at least three horizontal elements have at least one connecting element exiting from its side facing toward the first section, and being cast on site into the first section. As a result, a corresponding simple and secure connection of the horizontal elements to the pedestal is produced in a simple way.

A further teaching of the invention provides that the at least one tower fastening element is an anchor cage.

In the following text, the invention will be described in greater detail on the basis of exemplary embodiments in conjunction with a drawing, in which:

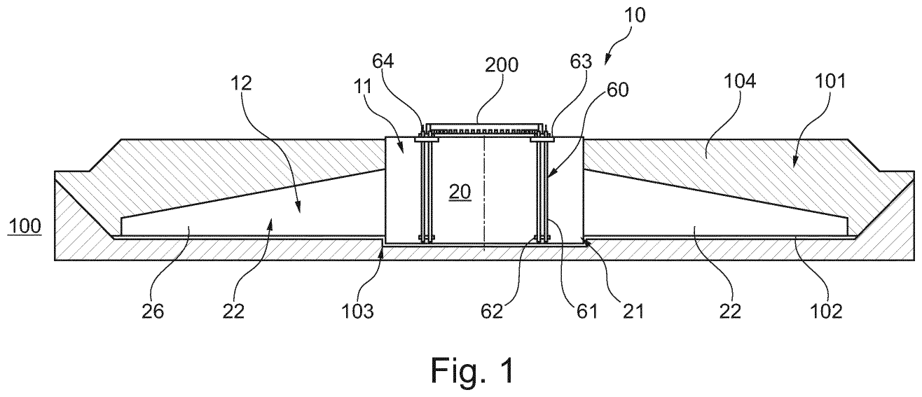

FIG. 1 shows a sectional side view of a foundation according to the invention,

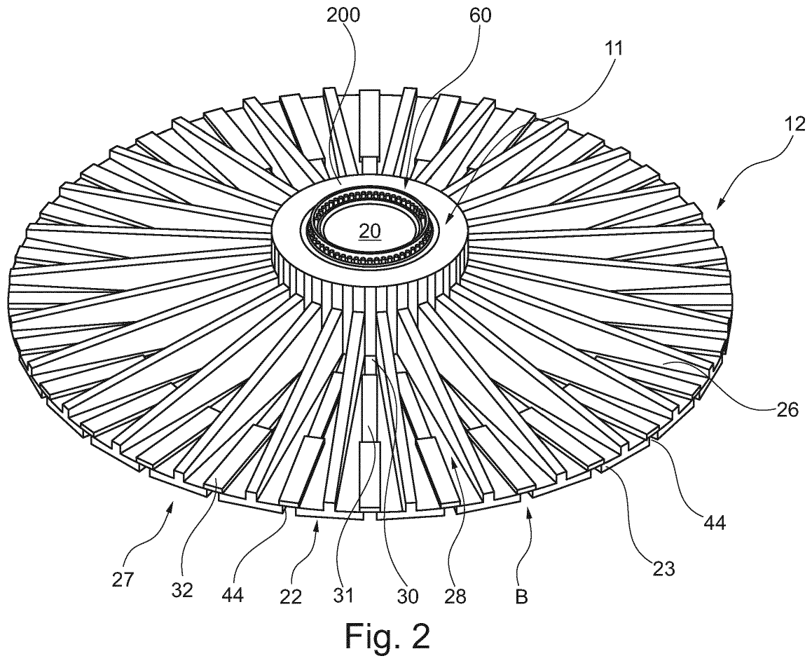

FIG. 2 shows a three-dimensional view with respect to FIG. 1,

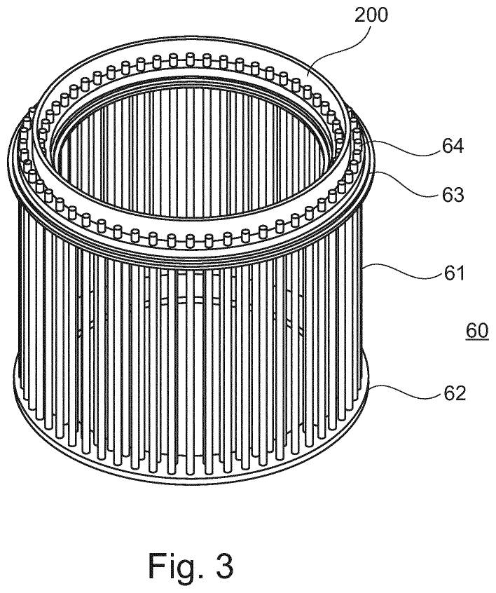

FIG. 3 shows a three-dimensional illustration of an anchor cage, as is used by way of example in the invention in conjunction with a connector flange of a tower of a wind power plant,

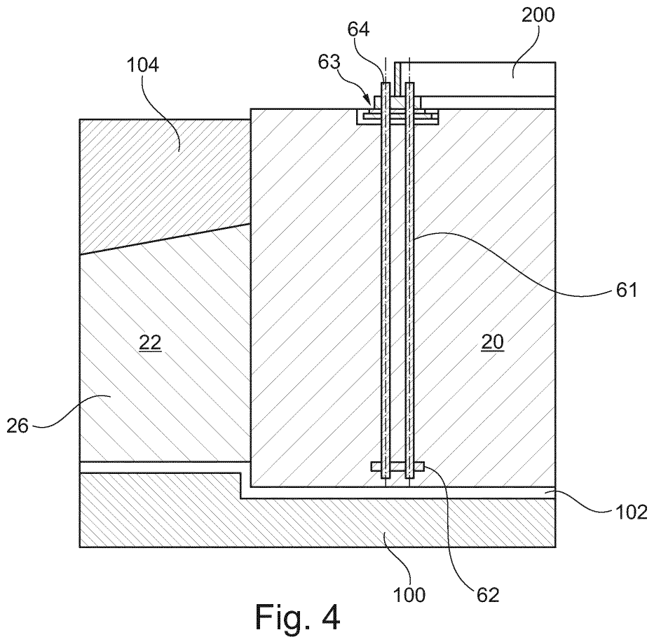

FIG. 4 shows a laterally sectioned enlarged detailed view with respect to FIG. 1,

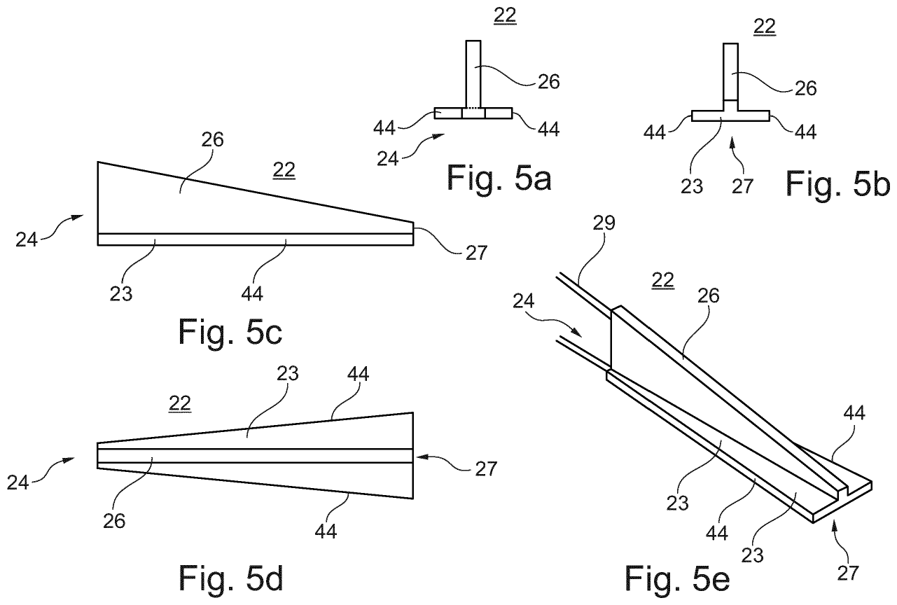

FIGS. 5a to 5e show views of one preferred exemplary embodiment of a horizontal element according to the invention,

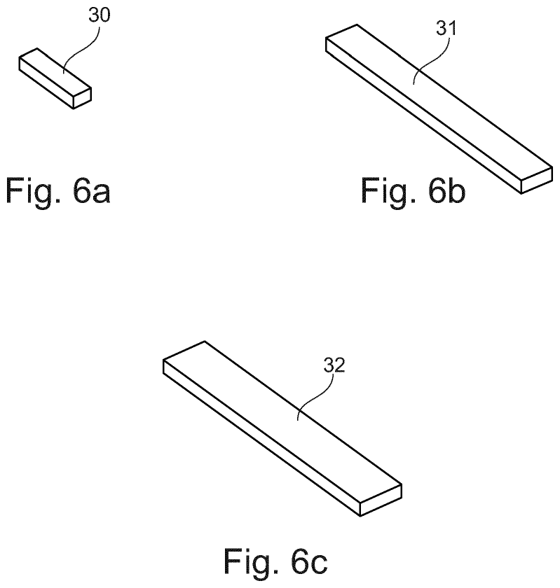

FIGS. 6a to 6c show three-dimensional views of covering elements according to the invention, and

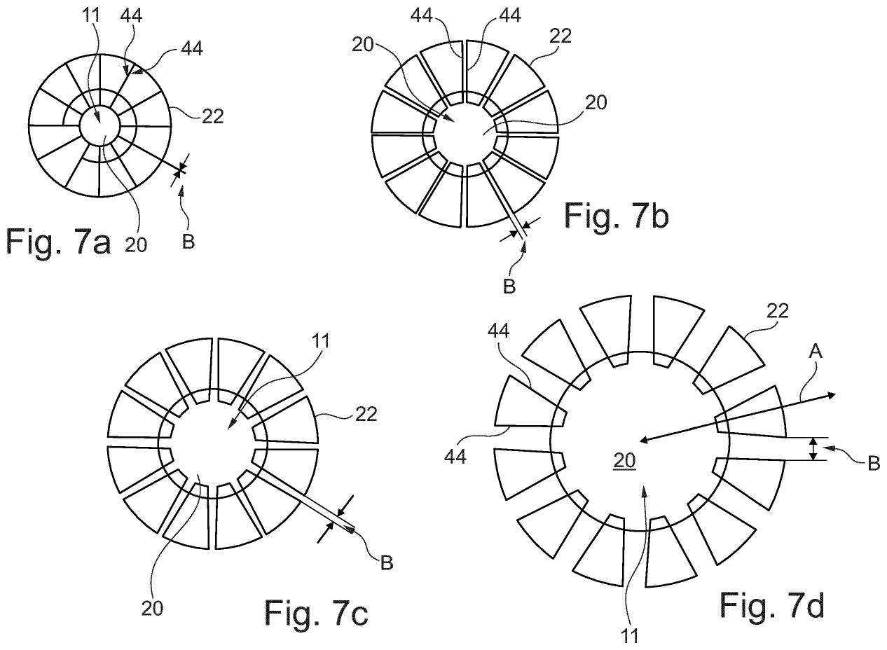

FIGS. 7a to 7d show diagrammatic illustrations of arrangement variants.

In FIG. 1, in a sectional view, one preferred embodiment of a foundation 10 is arranged in a pit 101 in the ground 100 on a granular subbase 102. They have a first pedestal-like section 11 and a second flat section 12 which is formed from horizontal elements 22. Furthermore, a third section (not shown) can also optionally be provided below the first section 11, or the first section can be configured above the second section so as to extend downward as a projection 21, which would then preferably be provided in each case in a depression 103.

The first section 11 is configured as a pedestal 20. An anchor cage 60 (see FIG. 3) and reinforcements (not shown) are in the pedestal 20 as tower fastening element. The anchor cage 60 as one example for a tower fastening element is composed of vertical bars 61 and rings 62, 63 which are arranged in each case at the bottom and at the top and are connected fixedly to one another. The upper ring 63 with the projecting bar sections 64 protrudes out of the concrete of the pedestal 20. For example, the connector flange 200 of the tower of the wind power plant is connected to this part of the anchor cage, for example by means of screw connections.

The second section 12 is of flat configuration. As an alternative, however, it can also be realized in a star shape. FIG. 2 shows a three-dimensional view of the foundation 10. The second section 12 is configured from horizontal elements 22 in the form of rib elements. These are shown in FIGS. 5a to 5e. They extend radially to the outside as viewed from the pedestal 20. They have a base plate 23 which is, for example, of trapezoidal configuration, with the result that all the assembled base plates form a polygonal area (see FIG. 2) which approximates a circular shape. As an alternative, circular segments (see FIGS. 7a to 7d) or a mixed form of circular segment and trapezoidal shape are also possible. Spacings B which are dependent on the diameter of the tower to be erected are provided between side walls 44 of the base plates 23.

A reinforcing wall 26 is arranged at a right angle on the base plate 23, the height of which reinforcing wall 26 decreases, for example, from the inner end 24 toward the outer end 27 of the base plate 23. An upwardly open cavity 28 is formed between two adjacent reinforcing walls 26, into which cavity 28 backfill ground 104 can be introduced, as a result of which a load can be applied to the second section 12 of the foundation 10.

Connecting elements 29 (here, preferably in the form of reinforcement bars) are provided at the inner end 24 of the horizontal element, which connecting elements 29 exit from the base plate and/or from the reinforcing wall 24 and, in the assembled state, protrude into the pedestal, for example in the direction of the anchor cage, and form a durable connection with the concrete of the pedestal 20.

The spacings B are preferably covered by way of covering plates 30, 31, 32, in order to achieve a surface which is, as it were, continuous below the cavity 28. As a result, the load action of the ground 104 is reinforced.

As FIGS. 7a to 7d show diagrammatically, it is possible to form a second section 12 with one and the same horizontal element 22, which second section 12 has a pedestal 20 of different size, by the horizontal elements 22 being displaced inward or outward along a line which emanates from the center point, as shown by way of a double arrow A in FIG. 7d. This is delimited toward the inside by virtue of the fact that the side faces 44 of the base plates 23 of the horizontal elements 22 are in contact with one another. Toward the outside, this is dependent on the radius of the tower (not shown) to be erected and therefore also the radius of the anchor cage. A spacing B is preferably identical over the entire length of the side faces 44 from the inner end 24 toward the outer end 27, with the result that two side faces 44 are arranged parallel to one another. As a result, foundations for towers with different diameters can preferably be erected in a simple way by way of a single horizontal element 22. The cavity 28 is then covered by way of the covering plates 30, 31, 32 (see FIGS. 6a-6c).

The foundation 10 is erected in a foundation pit 100, for example on a granular subbase 102, by at least one tower fastening element/anchor cage 60 being arranged in the pedestal section 11 of the foundation 10. The horizontal elements 22 are arranged radially around the tower fastening element 60, such that in each case at least one connecting element 29 which exits from the horizontal element 22 protrudes into the pedestal section 11 or the tower fastening element 60, the horizontal elements 22 being arranged in such a way that there is in each case a spacing B between the horizontal elements 22. Furthermore, reinforcements are introduced into the pedestal section 11. They can already be pre-manufactured, for example, and can be introduced as elements (not shown). Furthermore, formwork is provided which delimits the pedestal section spatially. The cast-in-place concrete is then introduced into the formwork into this space. The spacings B are closed by way of covering elements 30, 31, 32 toward the cavity 28. After hardening of the concrete, for example, the formwork is removed. Backfill ground 104 is then introduced as a load into the cavity 28. Subsequently, the tower of the wind power plant can be erected on the pedestal 20 in conjunction with the tower fastening element 60.

List of Designations

| | | | |
|---|---|---|---|
| 10 | Foundation | A | Displacement direction |
| 11 | First section/pedestal section | B | Spacing |
| 12 | Second section | | |
| 20 | Pedestal | | |
| 21 | Depression | | |
| 22 | Horizontal element/rib element | | |
| 23 | Base plate | | |
| 24 | Inner end | | |
| 26 | Reinforcing wall | | |
| 27 | Outer end | | |
| 28 | Cavity | | |
| 29 | Connecting element | | |
| 30 | Covering plate | | |
| 31 | Covering plate | | |
| 32 | Covering plate | | |
| 44 | Side face | | |
| 60 | Anchor cage | | |
| 61 | Bar | | |
| 62 | Lower ring | | |
| 63 | Upper ring | | |
| 64 | Bar end | | |
| 100 | Ground | | |
| 101 | Foundation pit | | |
| 102 | Granular subbase | | |
| 104 | Backfill ground | | |
| 200 | Connector flange | | |

1-8. (canceled)

9. A foundation for a wind tower including;
a first pedestal-like section cast from concrete at the erection site with at least one tower fastening element located therein and cast into on site, on which a tower of the wind power plant is arrangeable, and to which the tower of the wind power plant is connectable, and;
a second horizontally extending section configured as a flat foundation body, the second section arranged in connection with the first section, the second section including at least three prefabricated horizontal elements made from reinforced concrete;
wherein;
the at least three horizontal elements each have at least one base section with a reinforcing element extending substantially vertically thereon;
the horizontal elements are arrangeable in a manner which is dependent on the parameters of the tower to be erected, including the tower radius; and,
there is a spacing between each of the horizontal elements.

10. The foundation as claimed in claim 9, wherein the spacing is covered with at least one covering element.

11. The foundation as claimed in claim 9 wherein the first section includes at least partially prefabricated reinforcements which are cast on site.

12. The foundation as claimed in claim 9, wherein the at least three horizontal elements each include at least one connecting element exiting from an inner side of the horizontal element facing toward the first section, and wherein the at least one connecting element of the at least three horizontal elements are cast on site into the first section.

13. The foundation as claimed in claim 9 wherein the at least one tower fastening element is an anchor cage (60).

14. A method for producing a foundation for a wind power plant, comprising;
arranging at least one tower fastening element in a pedestal section of the foundation;
arranging at least three horizontal elements, prefabricated from concrete, radially around the tower fastening element, whereby for each horizontal element at least one connecting element exits from the horizontal element and protrudes into the pedestal section, and the horizontal elements are configured with a spacing between horizontal element;
providing reinforcements into the pedestal section;
erecting formwork for spatially delimiting the pedestal section, and;
providing cast-in-place concrete into the formwork.

15. The method as claimed in claim 14, wherein the at least one tower fastening element is an anchor cage.

16. The method as claimed in claim 14, wherein the spacing is covered by at least one covering element.

17. The foundation as claimed in claim 10, comprising an upwardly open cavity formed by adjacent reinforcing walls, the base plates and the at least one covering element for introducing backfill ground for applying load onto the second section of the foundation.

18. The foundation as claimed in claim 12, wherein the connecting element is a reinforcing bar.

19. The foundation as claimed in claim 12, wherein the at least one connecting element exits from at least one off the base plate or the reinforcing wall of the horizontal element.

20. The method as claimed in claim 16, comprising forming an upwardly open cavity between the adjacent reinforcing walls and the base plates by covering the spacing with the at least one covering element; and
introducing backfill ground into the cavity for applying load onto the second section of the foundation.
